(19) United States
(12) Patent Application Publication
(10) Pub. No.: US 2025/0006079 A1
(43) Pub. Date: Jan. 2, 2025

(54) Training Vessel for Helicopter Pilot Training

(71) Applicant: John M. Neuhart, II, Virginia Beach, VA (US)

(72) Inventor: John M. Neuhart, II, Virginia Beach, VA (US)

(21) Appl. No.: 18/757,979

(22) Filed: Jun. 28, 2024

Related U.S. Application Data
(60) Provisional application No. 63/523,871, filed on Jun. 28, 2023.

(51) Int. Cl. G09B 19/16; B63B 3/48; B63B 35/50; B64F 1/22

(52) U.S. Cl. CPC G09B 19/165; B63B 3/48; B63B 35/50; B64F 1/22

(57) ABSTRACT

A training vessel for training a helicopter pilot comprises a hull that includes a structural framework that supports at least an aft deck and a superstructure. The superstructure is positioned forward of the aft deck, the superstructure being disposed within a forward portion having a superstructure length that is between approximately ten percent (10%) and approximately forty percent (40%) of a scantling length of the hull. The aft deck includes a landing pad configured to withstand landing and takeoff forces during helicopter operations. The vessel includes a propulsion system configured to propel the vessel across a water surface.

### CROSS REFERENCE TO RELATED APPLICATIONS

This patent application claims priority benefits under 35 USC § 119(e) from the following provisional patent application: U.S. Patent Application No. 63/523,871 filed on Jun. 28, 2023, which application is incorporated herein by reference.

### FIELD OF THE DISCLOSURE

The present disclosure relates generally to systems and methods for helicopter pilot training, and more specifically, to improved vessels for helicopter pilot training.

### BACKGROUND

Landing a helicopter on a landing pad of a ship may present a particularly challenging task for a helicopter pilot. This is particularly true in conditions where the ship is underway, or when the ship is experiencing heavy seas or high winds. It is therefore important for a helicopter pilot to receive as much training as possible under a variety of adverse conditions to better prepare the pilot for the conditions that may be faced during actual operations.

Conventionally, military helicopter pilots may be trained using a full-scale military warship (known as an Air Capable Surface Combatant) having a single-spot helicopter landing pad. Alternately, an auxiliary vessel designed to perform other support functions may be used. These conventional vessels may be operated under a variety of circumstances to present the helicopter pilot with a set of conditions of ever-increasing difficulty. In this way, the helicopter pilot's experience and proficiency gradually increases with each new set of landing conditions that the helicopter pilot is allowed to train on and accomplish. Given the number of helicopter pilots needed for maritime operations, there is a high demand for such training.

It will be appreciated, however, that the use of full-scale military warships or auxiliary vessels as training devices for helicopter pilots is an undesirable solution. These vessels are valuable resources having significant non-training capabilities and relatively high operational costs. Because of the relatively high value of military warships and other auxiliary vessels, relatively few of such vessels are typically allocated for training. This results in a mismatch between the high demand for training helicopter pilots and the relatively-low availability of training vessels to conduct such training operations. Accordingly, although existing systems have achieved desirable results, there is room for improvement.

### SUMMARY

Systems and methods for helicopter pilot training, and more specifically, to improved vessels for helicopter pilot training. Embodiments of vessels for helicopter pilot training in accordance with the present disclosure may provide considerable advantages over the prior art. For example, embodiments of training vessels for helicopter pilot training in accordance with the present disclosure may be more safely, effectively, efficiently, economically, and widely deployed to better meet the high demand for helicopter pilot training in maritime operations, as described more fully below.

In some embodiments, a vessel for training a helicopter pilot comprises: a hull that includes a structural framework that supports at least an aft deck and a superstructure, the superstructure being operatively positioned forward of the aft deck proximate a bow of the hull, the superstructure being disposed within a forward portion having a superstructure length that is within a range of approximately ten percent (10%) and approximately forty percent (40%) of a scantling length of the hull, wherein the aft deck includes a landing pad configured to withstand landing and takeoff forces during helicopter operations; and a propulsion system at least partially disposed within the hull and configured to propel the vessel across a water surface.

Alternately, in some embodiments, a vessel for training a helicopter pilot, comprises: a hull that includes a structural framework that supports at least an aft deck and a superstructure, the superstructure being operatively positioned forward of the aft deck proximate a bow of the hull, the hull having a scantling length, the superstructure being disposed within a forward portion that extends from the bow, the forward portion being between approximately ten percent (10%) and approximately forty percent (40%) of the scantling length, the aft deck being positioned aft of the forward portion; a propulsion system at least partially disposed within the hull and configured to propel the vessel across a water surface; and wherein the aft deck includes a landing pad configured to withstand landing and takeoff forces during helicopter operations, wherein the aft deck has a deck midpoint, and wherein the landing pad has a pad midpoint that is disposed at or forward of the deck midpoint, the landing pad being coupled directly to the support framework of the hull and being configured to withstand landing impacts of approximately five gravities (5g's).

In still further embodiments, a vessel for training a helicopter pilot, comprises: a hull that includes a structural framework that supports an aft deck, the hull having a scantling length, wherein the aft deck includes a landing pad configured to withstand landing and takeoff forces during helicopter operations, wherein the landing pad is coupled directly to the support framework of the hull and has a landing pad midpoint that is disposed forward of or coincident with an aft deck midpoint of the aft deck; a superstructure operatively coupled to the structural framework and disposed within a forward portion that is forward of the aft deck and proximate to a bow of the hull, the forward portion having a superstructure length that is between approximately ten percent (10%) and approximately forty percent (40%) of the scantling length; and a propulsion system at least partially disposed within the hull and configured to propel the vessel across a water surface.

There has thus been outlined, rather broadly, some of the embodiments of the present disclosure in order that the detailed description thereof may be better understood, and in order that the present contribution to the art may be better appreciated. There are additional embodiments that will be described hereinafter and that will form the subject matter of the claims appended hereto. In this respect, before explaining at least one embodiment in detail, it is to be understood that the various embodiments are not limited in its application to the details of construction or to the arrangements of the components set forth in the following description or illustrated in the drawings. Also, it is to be understood that the phraseology and terminology employed herein are for the purpose of the description and should not be regarded as limiting.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evidence to the contrary from the description, where elements in different figures use identical reference numbers, the elements are generally either identical or at least similar in function or purpose.

### BRIEF DESCRIPTION OF THE DRAWINGS

Embodiments of methods and systems in accordance with the teachings of the present disclosure are described in detail below with reference to the following drawings.

FIG. 1 is a perspective view of an embodiment of a vessel for helicopter pilot training in accordance with an embodiment of the present disclosure.

FIG. 2 is another perspective view of the vessel for helicopter pilot training of FIG. 1 in accordance with an embodiment of the present disclosure.

FIG. 3 is a side elevational view of the vessel for helicopter pilot training of FIG. 1 in accordance with an embodiment of the present disclosure.

FIG. 4 is a top view of the vessel for helicopter pilot training of FIG. 1 in accordance with an embodiment of the present disclosure.

FIG. 5 is a side elevational view of a vessel for helicopter pilot training in accordance with another embodiment of the present disclosure.

FIG. 6 is a top view of the vessel for helicopter pilot training of FIG. 5 in accordance with another embodiment of the present disclosure.

FIG. 7 is a side elevational view of a vessel for helicopter pilot training in accordance with another embodiment of the present disclosure.

FIG. 8 is a top view of the vessel for helicopter pilot training of FIG. 7 in accordance with another embodiment of the present disclosure.

### DETAILED DESCRIPTION

Systems and methods for helicopter pilot training, and more specifically, to improved vessels for helicopter pilot training, are described herein. Many specific details of certain embodiments are set forth in the following description and in the accompanying figures to provide a thorough understanding of such embodiments. One skilled in the art will understand, however, that the invention may have additional embodiments, or that alternate embodiments may be practiced without several of the specific details set forth in the following description.

In some embodiments, a vessel in accordance with the present disclosure may include a hull that includes a structural framework that supports at least an aft deck and a superstructure, the superstructure being operatively positioned forward of the aft deck proximate a bow of the hull. Moreover, the superstructure is disposed within a forward portion that extends from the bow rearwardly toward the aft deck, wherein the forward portion is between approximately ten percent (10%) and approximately forty percent (40%) of a scantling length of the hull. The aft deck is positioned aft of the forward portion, and the aft deck includes a landing pad configured to withstand landing and takeoff forces during helicopter operations. The vessel may further include a propulsion system at least partially disposed within the hull and configured to propel the vessel across a water surface.

In some embodiments, the aft deck is a single level deck that extends between approximately ninety percent (90%) and approximately sixty percent (60%) of the scantling length. In further embodiments, the landing pad is disposed proximate to the forward portion and extends approximately fifty percent (50%) of the scantling length. In still further embodiments, the vessel comprises at least one of an Offshore Supply Vessel, an Offshore Support Vessel (OSV), a Platform Supply Vessel, or a Platform Support Vessel (PSV). More specifically, in some embodiments, the vessel is at least one of constructed or certificated under at least one of Title 46 of the U.S. Code of Federal Regulations Subchapters (I) or (L). These and other aspects of embodiments of vessels for helicopter pilot training in accordance with the present disclosure will be described more fully below with reference to the accompanying drawings.

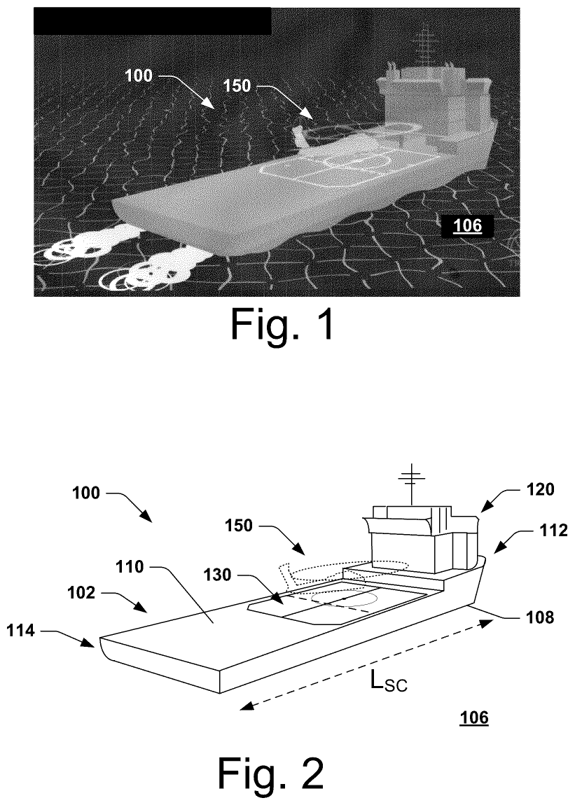

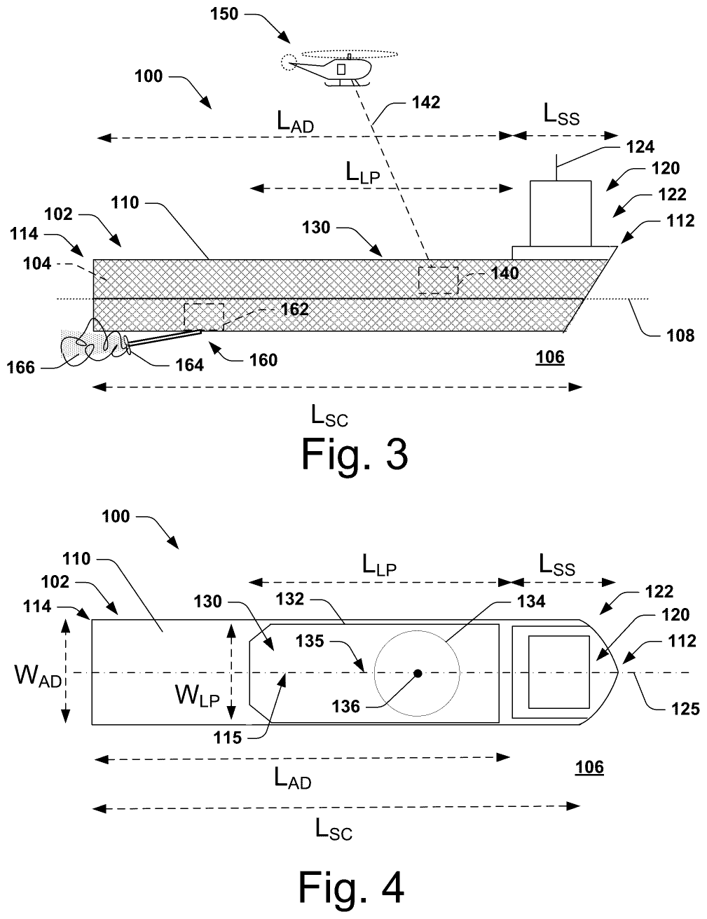

More specifically, FIGS. 1 and 2 are perspective views of a vessel 100 for helicopter pilot training in accordance with an embodiment of the present disclosure. FIGS. 3 and 4 are side and top views of the vessel 100 of FIG. 1. In the embodiment shown in FIGS. 1-4, the vessel 100 includes a hull 102 that includes a structural framework 104 (shown generally as an internal framework in FIG. 3) that supports at least an aft deck 110 and a superstructure 120.

It will be appreciated that the vessel 100 is shown operating in a marine environment 106 so that in FIGS. 1-2 and 4, only those portions of the vessel 100 that are above a waterline 108 are visible. In FIG. 3, a submerged portion of the vessel 100 below the waterline 108 is depicted. In addition, the hull 102 of the vessel 100 is characterized by a scantling length L_{SC}. The scantling length L_{SC} is a term commonly used in marine vessels and is herein defined as a distance approximately equal to a length of the vessel 100 (or the hull 102) at the waterline 108, and is typically less than an overall length of the vessel 100.

As further shown in FIGS. 1-4, the superstructure 120 is operatively positioned forward of the aft deck 110, proximate a bow 112 of the hull 102. The superstructure 120 is disposed within a forward portion 122 that extends from the bow 112 rearwardly toward the aft deck 110. In general, the superstructure 120 is an elevated portion of the vessel 100 that is rises above the hull 102 and provides facilities and equipment that are generally known for enabling the crew of the vessel 100 to perform proper command and control of the vessel 100 during maritime operations. For example, in some embodiments, the superstructure 120 may include an antenna 124 for communications or for performing other desirable operations (e.g. radar). In some embodiments, the superstructure 120 includes an aviation control station that faces aft that permits viewing of the aft deck 110 (and the landing pad 130) where a crew member can observe and assist with training operations, such as ship-aircraft communications and safety.

As best shown in FIG. 4, the vessel 100 has a centerline 125 that extends along an entire length of the vessel 100 from the bow 112 to a stem 114 of the vessel 100. The forward portion 122 of the vessel 100 is characterized by a superstructure length L_{SS} which extends along the centerline 125 from the bow 112 to the aft deck 110. In the embodiment shown in FIGS. 1-4, the superstructure length L_{SS} is shown as being within a range of approximately twenty percent to twenty-five percent of the scantling length L_{SC} of the vessel 100 (i.e. ˜20%<=L_{SS}/L_{SC}<=˜25%) (see FIGS. 3-4). In alternate embodiments, however, the superstructure length L_{SS} may be a greater or lesser proportion of the scantling length L_{SC}. For example, in alternate embodiments, the superstructure length L_{SS} may be as small as approximately ten percent (10%) of the scantling length L_{SC}, while in further embodiments, the superstructure length L_{SS} may be as large as approximately forty percent (40%) of the scantling length L_{SC} of the vessel 100.

Similarly, the aft deck 110 is positioned aft of the forward portion 122. In some embodiments, the aft deck 110 is a single level deck. The aft deck 110 is characterized by an aft deck length L_{AD} which extends along the centerline 125 from the stem 114 to the forward portion 122. In the embodiment shown in FIGS. 1-4, the aft deck length L_{AD} is shown as being within a range of approximately eighty percent to seventy-five percent of the scantling length L_{SC} of the vessel 100 (i.e. ˜80%>=L_{AD}/L_{SC}>=˜75%) (see FIGS. 3-4). In alternate embodiments, however, the aft deck length L_{AD} may be a greater or lesser proportion of the scantling length L_{SC}. For example, in alternate embodiments, the aft deck length L_{AD} may be as large as approximately ninety percent (90%) of the scantling length L_{SC}, while in further embodiments, the aft deck length L_{AD} may be as small as approximately sixty percent (60%) of the scantling length L_{SC} of the vessel 100 (i.e. ˜90%>=L_{AD}/L_{SC}>=˜60%).

As further shown in FIGS. 1-4, the aft deck 110 includes a landing pad 130 configured to withstand landing and takeoff forces during operations of a helicopter 150. In some presently-preferred embodiments, the landing pad 130 may be coupled directly to the support framework 104 of the hull 102. In some embodiments, the landing pad 130 is disposed proximate to the forward portion 122 of the vessel 100, however, in alternate embodiments, the landing pad 130 may be spaced apart from the forward portion 122 and positioned further aft on the aft deck 110. To more accurately simulate actual operating conditions, such as those that may be experienced when landing on a variety of military vessels, the landing pad 130 may be positioned immediately aft of and below the level of the superstructure 120. In the embodiment shown in FIGS. 1-4, the landing pad 130 has a generally rectangular shape and includes a perimeter line 132 that generally indicates a touchdown and liftoff area, which is a load-bearing area on which the helicopter 150 may land or take off. In other embodiments, the landing pad 130 may have a somewhat tapered rectangular shape (or other suitable shape) to conform to the overall beam dimensions of the vessel 100. The landing pad 130 further includes a touchdown position circle 134 having a centerpoint 136 that indicates a desired or target landing location of the helicopter 150. In general, in some embodiments, the landing pad 130 may have highly precise markings (i.e. perimeter line 132, touchdown position circle 134, etc.) to simulate actual landing pad conditions and to properly support precision landings and safe external sling load operations. In some embodiments, the landing pad 130 is marked with markings as specified by the U.S. Navy, or the U.S. Department of Defense, or other relevant authority. Similarly, in some embodiments, the landing pad 130 of the vessel 100 may be equipped with lighting equipment (e.g. along the perimeter line 132, touchdown position circle 134, etc.) to properly support day and night glideslope training operations. Also, in some embodiments, the landing pad 130 of the vessel 100 may be equipped with a day and night artificial horizon reference that is compensated for ship rolls. It will be appreciated that lighting associated with the landing pad 130 usually consists of perimeter (deck edge) lighting and center-line lights, while an artificial horizon and visual glide slope indicators are normally affixed to the superstructure 120. Additionally, there are normally deck status lights (that convey the status of the deck for take-off and landing) affixed to the superstructure 120. In some embodiments, the lights associated with the landing pad 130 and/or the superstructure 120 may have a setting for when the crews are equipped with night vision devices to reduce the overall intensity, and may be tuned to a specific wavelength to avoid overloading the sensitive light amplification features of the night vision devices.

It will be appreciated that the landing pad 130 may have a variety of suitable configurations. In general, the specifications and requirements of the landing pad 130 may be relatively higher for training with military helicopters for military operations, and relatively lower for training with civilian helicopters for civilian operations. For example, in some embodiments, the landing pad 130 has a landing weight capacity of between approximately twenty thousand pounds and approximately ninety thousand pounds, which may be more suitable for typical helicopters used in military operations. And in some embodiments, the landing pad 130 is configured to withstand landing impacts of approximately five gravities (5g's), which is currently standard of the U.S. Navy. Of course, in further embodiments, the landing pad 130 may be configured to withstand landing impacts of greater or lesser impacts in accordance with evolving standards and requirements. Alternately, in some embodiments, the landing pad 130 has a capacity of 2010 N/m2 (i.e. 205 kgf/m2, 42 lbf/ft2), which may be more suitable for typical helicopters used in civilian operations. In some embodiments, the landing pad 130 may be operatively coupled directly to the structural framework 104 of the hull 102 in order to better meet the loading requirements and capabilities required for training helicopter pilots, such as for military helicopter operations which may be more strenuous than for typical civilian helicopter operations. In general, in some embodiments, the landing pad 130 may be configured to meet or exceed the specifications and requirements as set forth in the “Guide for the Class Notation, Helicopter Decks and Facilities” published by the American Bureau of Shipping dated April 2008 (updated October 2015).

As shown in FIG. 3, in some embodiments, the landing pad 130 may include a haul-down system 140 that is configured to apply a biasing force to the helicopter 150 during a landing. For example, in some embodiments, the haul-down system 138 may be of a type generally known as a RAST (Recovery Assist, Secure and Traverse) system. In brief, the haul-down system 140 may operate by attaching a tethering cable 142 to the helicopter 150 (e.g. by lowering a messenger cable from the helicopter 150 to the vessel 100 and then hauling up the tethering cable 142 to the helicopter 150), and then applying tension to the tethering cable 142 to apply a biasing force to the helicopter 150 during the landing, helping to stabilize and direct the helicopter 150 onto the landing pad 130. Following landing, the RAST system may also secure the helicopter 150 on the landing pad 130, and may also be used to traverse the helicopter 150 to another location, such as to another location on the landing pad 130, or to a hanger or other suitable location on the aft deck 110. It will be appreciated that the haul-down system 140 may be more typically employed for training helicopter pilots associated with military operations, and may be omitted or not employed for training for civilian helicopter operations, however, the haul-down system 140 may or may not be used for both military or civilian helicopter training.

In some embodiments, the landing pad 130 may be co-planar with the aft deck 110 (or upper surface of the aft deck 110), however, in further embodiments, the landing pad 130 may be slightly raised above the aft deck 110. For example, in some embodiments, the landing pad 130 may be raised above the aft deck 110 to accommodate other components or systems, such as portions of the haul-down system 140, or portions of a firefighting system (e.g. piping, tanks, pumps, etc.), or any other devices or systems (e.g. drainage systems, etc.).

The landing pad 130 of the vessel 100 is characterized by a landing pad length L_{LP} which extends along the centerline 125. For example, in some representative embodiments, the landing pad length L_{LP} may be approximately 30 feet to approximately 140 feet in length. In the embodiment shown in FIGS. 1-4, the landing pad length L_{LP} is shown as being approximately fifty percent (50%) of the scantling length L_{SC} of the vessel 100 (i.e. L_{LP}/L_{SC}=˜50%) (see FIGS. 3-4). In alternate embodiments, however, the landing pad length L_{LP} may be a greater or lesser proportion of the scantling length L_{SC}. For example, in alternate embodiments, the landing pad length L_{LP} may be as small as approximately twenty percent (20%) of the scantling length L_{SC}, while in further embodiments, the landing pad length L_{LP} may be as large as approximately ninety percent (90%) of the scantling length L_{SC} of the vessel 100 (i.e. ˜90%>=L_{LP}/L_{SC}>=˜60%).

As shown in FIG. 4, in some embodiments, the landing pad 130 has a landing pad midpoint 135 that is located along the centerline 125, and the aft deck 110 has an aft deck midpoint 115 that is also located along the centerline 125. In the embodiment shown in FIGS. 1-4, the landing pad midpoint 135 is disposed forward of the aft deck midpoint 115 (e.g. by approximately twenty percent (20%) of the scantling length L_{SC}). In alternate embodiments, however, the landing pad midpoint 135 may be disposed further aft or even coincident with the aft deck midpoint 115.

With continued reference to FIG. 4, the landing pad 130 is further characterized by a landing pad width W_{LP} which extends transversely to the centerline 125, and the aft deck 110 has an aft deck width W_{AD} which also extends transversely to the centerline 125. For example, in some representative embodiments, the landing pad width W_{LP} may be approximately 50 feet to approximately 60 feet in width. In the embodiment shown in FIGS. 1-4, the landing pad width W_{LP} is shown as being approximately ninety-five percent (95%) of the aft deck width W_{AD} (i.e. W_{LP}/W_{AD}=˜95%) (see FIGS. 3-4). In alternate embodiments, however, the landing pad width W_{LP} may be a greater or lesser proportion of the aft deck width W_{AD}. For example, in alternate embodiments, the landing pad width W_{LP} may be as small as approximately seventy-five percent (75%) of the aft deck width W_{AD}, while in further embodiments, the landing pad width W_{LP} may be as large as approximately one hundred twenty-five percent (125%) of the aft deck width W_{AD} (i.e. ˜125%>=W_{LP}/W_{AD}>=˜75%).

Additionally, the vessel 100 includes a propulsion system 160 at least partially disposed within the hull 102 and configured to propel the vessel 100 across a surface of the marine environment 106. It will be appreciated that the propulsion system 160 may have a wide variety of suitable configurations, the details of which are well known. For example, as shown in FIG. 3, the propulsion system 160 includes one or more engines 162 disposed within the hull 102 that are operatively coupled to one or more propellers (or screws) 164 to generate one or more propulsive wakes 166. The propulsion system 160 generally includes a control system (not shown) that enables the propulsion system 160 to be operated from the superstructure 120 or other locations within the vessel 100.

In operation, the vessel 100 may be operated under a variety of circumstances to present the helicopter pilot with a realistic set of conditions of ever-increasing difficulty. In this way, the vessel 100 in accordance with the present disclosure may be used in training operations that enable the helicopter pilot's experience and proficiency to gradually increase with each new set of landing conditions that the helicopter pilot is allowed to train on and accomplish.

In some embodiments, the training vessel 100 may be constructed or certificated under Title 46 of the U.S. Code of Federal Regulations, Subchapters (I) or (L). In some embodiments, the vessel 100 may be categorized as what is commonly known as an Offshore Supply (or Support) Vessel (OSV), or a Platform Supply (or Support) Vessel (PSV). Typically, a PSV may be considered a type of OSV. At present, the U.S. Code of Federal Regulations (at 46 C.F.R. § 125.160) defines an OSV as having the following four characteristics: (1) is propelled by machinery other than steam; (2) does not meet the definition of a passenger-carrying vessel in 46 U.S.C. 2101(22) or 46 U.S.C. 2101(35); (3) is more than fifteen (15) gross tons; and (4) regularly carries goods, supplies, individuals in addition to the crew, or equipment in support of exploration, exploitation, or production of offshore mineral or energy resources. In some embodiments, however, the vessel 100 may meet characteristics (1)-(3) set forth above, and may also be characterized as having the superstructure 120 in the forward portion 122 of the vessel 100 and having an aft deck 110 capable of temporary equipment or affixing of permanent equipment, including the landing pad 130, as disclosed herein.

Embodiments of vessels for helicopter pilot training in accordance with the present disclosure may provide considerable advantages over the prior art. For example, embodiments of vessels for helicopter pilot training in accordance with the present disclosure may provide the desired training capabilities using a single-point landing vessel that is far more economical to operate. Because training vessels in accordance with the present disclosure may be configured with the landing pad proximate to the superstructure, such training vessels may provide realistic landing scenarios that simulate those of a full-scale military vessel. As noted above, in some embodiments, the training vessel may be an Offshore Supply Vessel, an Offshore Support Vessel (OSV), a Platform Supply Vessel, or a Platform Support Vessel (PSV), and may be constructed or certificated under Title 46 of the U.S. Code of Federal Regulations, Subchapters (I) or (L), such that the training vessel may provide the desired maritime operational capabilities desired for proper training operations, and yet may still be relatively inexpensive to construct and operate in comparison with current alternatives, such a full-scale military warship allocated for helicopter training operations. Such OSV and PSV vessels may also be capable of operating ship-to-aircraft navigation equipment that may be required for proper training exercises for military (or civilian) operations. In addition, OSV and PSV are designed to be stable at all speeds and usually have active or passive stability systems installed, and are typically built in very strong way, similar to surface combatants to be able to repeatedly handle heavy work and maneuvering loads.

In addition, embodiments of vessels for helicopter pilot training in accordance with the present disclosure may advantageously provide training conditions that accurately simulate actual operating conditions. Because the superstructure of the training vessel is disposed within the forward portion proximate the bow of the vessel, with the landing pad proximate to (or immediately aft of) the superstructure, the training vessel closely approximates a majority of existing single-spot landing vessels, especially those used for military operations. In contrast, many full-scale warships currently allocated for helicopter pilot training, such as large amphibious helicopter carriers or full-scale aircraft carriers, typically have large unobstructed landing and take-off paths so that landing a helicopter on one of these vessels is like landing at an airport. Specifically, in some embodiments, all forward motion must be arrested prior to touchdown, whereas at an airport (or large training vessel), if the aircraft drifts a little forward, aft, or even laterally (withing stability limits) the maneuver is safe. With my concept, which mimics the fleet warships, drift forward will result in catastrophic loss of the rotor system and possibly the entire aircraft and crew. Accordingly, embodiments of training vessels for helicopter pilot training in accordance with the present disclosure provide training of the specific skills required for actual fleet operations.

In addition, because such training vessels may be modified versions of relatively low cost OSV and PSV vessels, and because such training vessels specifically do not have any offensive military capabilities in the form of naval guns, armament, or other weaponry typical of a military surface combatant, there is no ordinance on board the training vessel that may cause negative consequences in the event of an accident during helicopter pilot training. Similarly, due to the reduced functionalities and capabilities of such training vessels in comparison with standard military vessels (i.e. no offensive military capabilities), there are far fewer personnel required to properly man and operate such training vessels in comparison with the prior art, further reducing operational costs and improving overall safety by placing fewer personnel in harm's way during training exercises. Accordingly, embodiments of training vessels for helicopter pilot training in accordance with the present disclosure may be more safely, effectively, efficiently, economically, and widely deployed to better meet the high demand for helicopter pilot training in maritime operations.

It will be appreciated that a wide variety of embodiments of vessels in accordance with the present disclosure may be conceived, and that the invention is not limited to the particular embodiments described above with respect to FIGS. 1-4. In the following discussion, a few alternate embodiments of vessels for helicopter pilot training will be briefly described. It should be noted that additional embodiments may be conceived by varying or combining various aspects of the described embodiments. For the sake of brevity, in the discussion of alternate embodiments below, only significant or substantial differences are described in detail.

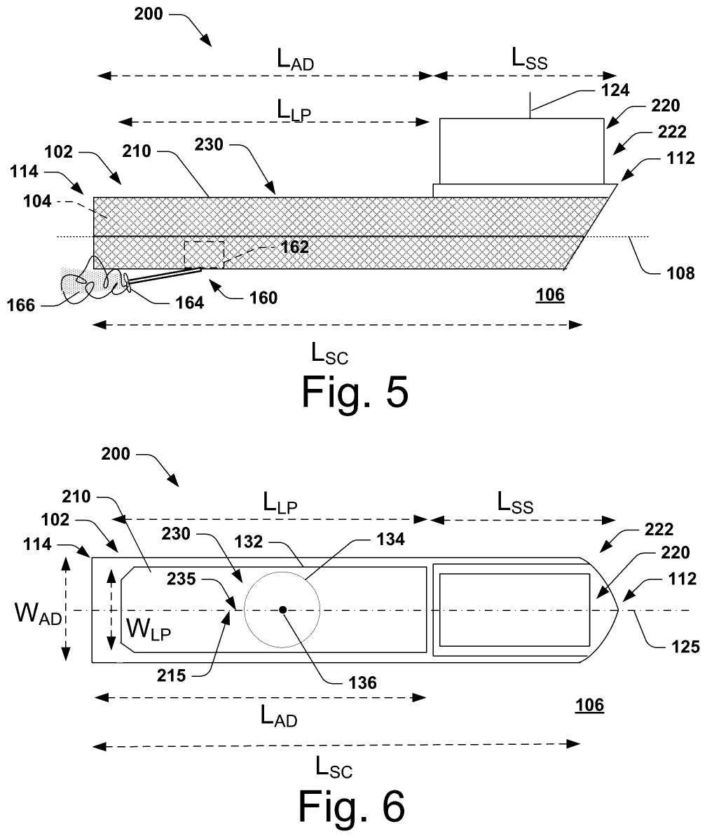

For example, FIG. 5 is a side elevational view of a vessel 200 for helicopter pilot training in accordance with another embodiment of the present disclosure. FIG. 6 is a top view of the vessel 200 of FIG. 5. In this embodiment, the vessel 200 includes a superstructure 220 that is larger than the vessel 100 described above and shown in FIGS. 1-4. More specifically, the superstructure 220 of the vessel 200 occupies a forward portion 222 having a superstructure length L_{SS} that is approximately thirty-five percent of the scantling length L_{SC} of the vessel 200 (i.e. L_{SS}/L_{SC}=˜35%) (see FIGS. 5-6). The vessel 200 further includes an aft deck 210 having an aft deck length L_{AD} that is approximately sixty-five percent of the scantling length L_{SC} of the vessel 200 (i.e. L_{AD}/L_{SC}=˜65%). Also, the vessel 200 includes a landing pad 230 having a landing pad length L_{LP} that is approximately sixty percent of the scantling length L_{SC} of the vessel 200 (i.e. L_{LP}/L_{SC}=˜60%).

As best shown in FIG. 6, in this embodiment, the landing pad 230 of the vessel 200 has a landing pad width W_{LP} that is approximately seventy-five percent (75%) of the aft deck width W_{AD} (i.e. W_{LP}/W_{AD}=˜75%). Moreover, because the landing pad length L_{LP} is only slightly shorter than the aft deck length L_{AD}, the landing pad midpoint 235 is nearly coincident with, and only slightly forward of, the aft deck midpoint 215.

Accordingly, the above-described advantages of vessels for training helicopter pilots in accordance with the present disclosure may be achieved using the vessel 200 having a relatively larger superstructure 200 and a landing pad 230 that is more closely comparable in length to the aft deck 230. Also, the landing pad 230 may be relatively narrower than the aft deck 230 to accommodate, for example, increased safety margins. Thus, the configuration of the vessel 200 may be tailored to provide an enlarged landing pad 230 for less experienced pilots, or to better simulate various landing pad conditions that may be experienced by helicopter pilots during actual operations.

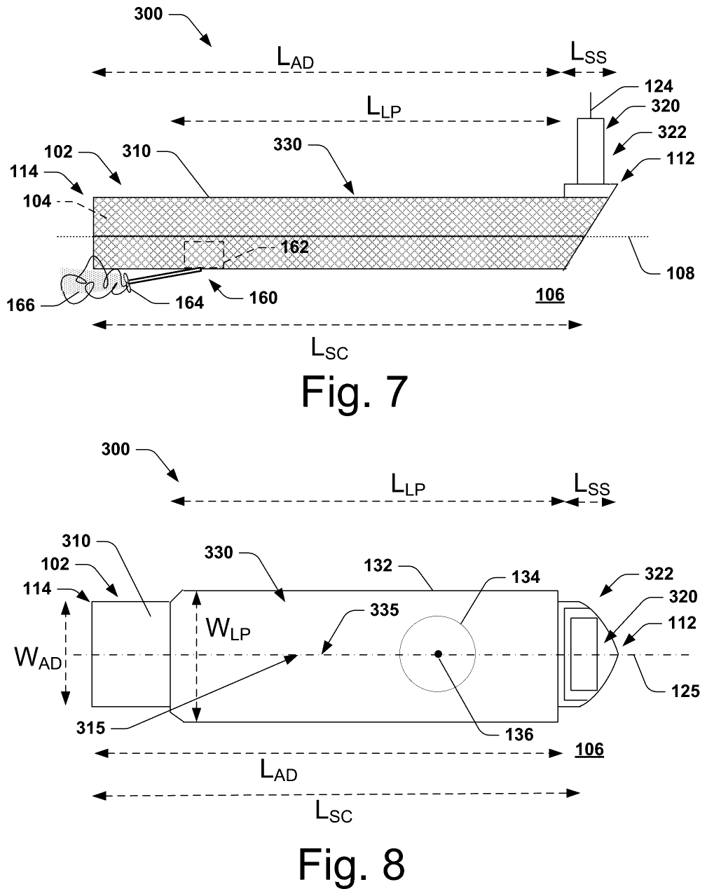

Similarly, FIG. 7 is a side elevational view of a vessel 300 for helicopter pilot training in accordance with another embodiment of the present disclosure. FIG. 8 is a top view of the vessel 300 of FIG. 7. In this embodiment, the vessel 300 includes a superstructure 320 that is smaller than the vessel 100 described above and shown in FIGS. 1-4. More specifically, the superstructure 320 of the vessel 300 occupies a forward portion 322 having a superstructure length L_{SS} that is approximately ten percent of the scantling length L_{SC} of the vessel 300 (i.e. L_{SS}/L_{SC}=˜10%) (see FIGS. 7-8). The vessel 300 further includes an aft deck 310 having an aft deck length L_{AD} that is approximately ninety percent of the scantling length L_{SC} of the vessel 300 (i.e. L_{AD}/L_{SC}=˜90%). Also, the vessel 300 includes a landing pad 330 having a landing pad length L_{LP} that is approximately seventy-five percent of the scantling length L_{SC} of the vessel 300 (i.e. L_{LP}/L_{SC}=˜75%).

As best shown in FIG. 8, in this embodiment, the landing pad 330 of the vessel 300 has a landing pad width W_{LP} that is approximately one hundred and twenty-five percent (125%) of the aft deck width W_{AD} (i.e. W_{LP}/W_{AD}=˜125%). The landing pad midpoint 335 is appreciably forward of the aft deck midpoint 315.

Accordingly, the above-described advantages of vessels for training helicopter pilots in accordance with the present disclosure may be achieved using the vessel 300 having a relatively smaller superstructure 300 and a landing pad 330 that is relatively large and wider than the width of the aft deck 310. Thus, the configuration of the vessel 300 may be tailored to provide an enlarged landing pad 330 for varying pilot training or to better simulate various landing pad conditions that may be experienced by helicopter pilots during actual operations.

Based on the foregoing detailed description, a non-exhaustive listing of possible embodiments of vessels for training a helicopter pilot will now be described. In some embodiments, a vessel for training a helicopter pilot comprises: a hull that includes a structural framework that supports at least an aft deck and a superstructure, the superstructure being operatively positioned forward of the aft deck proximate a bow of the hull, the superstructure being disposed within a forward portion having a superstructure length that is within a range of approximately ten percent (10%) and approximately forty percent (40%) of a scantling length of the hull, wherein the aft deck includes a landing pad configured to withstand landing and takeoff forces during helicopter operations; and a propulsion system at least partially disposed within the hull and configured to propel the vessel across a water surface.

In some embodiments, the aft deck is a single level deck that extends between approximately ninety percent (90%) and approximately sixty percent (60%) of the scantling length. Similarly, in some embodiments, the forward portion extends between approximately ten percent (10%) and approximately twenty percent (20%) of the scantling length from the bow. And in some embodiments, the aft deck is a single level deck that extends between approximately ninety percent (90%) and approximately eighty percent (80%) of the scantling length.

In addition, in some embodiments, the landing pad is disposed proximate to the forward portion and extends approximately fifty percent (50%) of the scantling length. In some embodiments, the landing pad has a landing weight capacity of between approximately twenty thousand pounds and approximately ninety thousand pounds. And in some embodiments, the landing pad is coupled directly to the support framework of the hull and is configured to withstand landing impacts of approximately five gravities (5g's).

In further embodiments, the landing pad includes a haul-down system configured to apply a biasing force to a helicopter during a landing. And in some embodiments, the hull has a maximum hull width, and wherein the landing pad is a rectangular shape having a pad width that is between approximately seventy fifty percent (75%) and approximately one hundred twenty five percent (125%) of the maximum hull width. In further embodiments, the aft deck has a deck midpoint, and wherein the landing pad has a pad midpoint that is disposed at or forward of the deck midpoint.

In some embodiments, the vessel comprises at least one of an Offshore Supply Vessel, an Offshore Support Vessel (OSV), a Platform Supply Vessel, or a Platform Support Vessel (PSV). And in some embodiments, the vessel is at least one of constructed or certificated under at least one of Title 46 of the United States of America Code of Federal Regulations Subchapters (I) or (L).

Alternately, in some embodiments, a vessel for training a helicopter pilot, comprises: a hull that includes a structural framework that supports at least an aft deck and a superstructure, the superstructure being operatively positioned forward of the aft deck proximate a bow of the hull, the hull having a scantling length, the superstructure being disposed within a forward portion that extends from the bow, the forward portion being between approximately ten percent (10%) and approximately forty percent (40%) of the scantling length, the aft deck being positioned aft of the forward portion; a propulsion system at least partially disposed within the hull and configured to propel the vessel across a water surface; and wherein the aft deck includes a landing pad configured to withstand landing and takeoff forces during helicopter operations, wherein the aft deck has a deck midpoint, and wherein the landing pad has a pad midpoint that is disposed at or forward of the deck midpoint, the landing pad being coupled directly to the support framework of the hull and being configured to withstand landing impacts of approximately five gravities (5g's).

In some embodiments, the forward portion extends between approximately ten percent (10%) and approximately twenty percent (20%) of the scantling length from the bow, and wherein the aft deck is a single level deck that extends between approximately ninety percent (90%) and approximately eighty percent (80%) of the scantling length. And in some embodiments, the hull has a maximum hull width, and wherein the landing pad is a rectangular shape having a pad width that is between approximately seventy fifty percent (75%) and approximately one hundred twenty five percent (125%) of the maximum hull width.

In still further embodiments, a vessel for training a helicopter pilot, comprises: a hull that includes a structural framework that supports an aft deck, the hull having a scantling length, wherein the aft deck includes a landing pad configured to withstand landing and takeoff forces during helicopter operations, wherein the landing pad is coupled directly to the support framework of the hull and has a landing pad midpoint that is disposed forward of or coincident with an aft deck midpoint of the aft deck; a superstructure operatively coupled to the structural framework and disposed within a forward portion that is forward of the aft deck and proximate to a bow of the hull, the forward portion having a superstructure length that is between approximately ten percent (10%) and approximately forty percent (40%) of the scantling length; and a propulsion system at least partially disposed within the hull and configured to propel the vessel across a water surface.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All patent applications, patents, and printed publications cited herein are incorporated herein by reference in their entireties, except for any definitions, subject matter disclaimers or disavowals, and except to the extent that the incorporated material is inconsistent with the express disclosure herein, in which case the language in this disclosure controls.

The present invention may be embodied in other specific forms without departing from the spirit or essential attributes thereof, and it is therefore desired that the present embodiment be considered in all respects as illustrative and not restrictive. Many modifications and other embodiments of the present disclosure will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the embodiments in the present disclosure, suitable methods and materials are described above. Thus, the present disclosure is not intended to be limited to the embodiments shown, but is to be accorded the widest scope consistent with the principles and features disclosed herein.

While various embodiments have been described above, it should be understood that they have been presented by way of example only, and not limitation. The descriptions are not intended to limit the scope of the technology to the particular forms set forth herein. To the contrary, the present descriptions are intended to cover such alternatives, modifications, and equivalents as may be included within the spirit and scope of the technology as defined by the appended claims and otherwise appreciated by one of ordinary skill in the art. The various embodiments of the present disclosure may be embodied in other specific forms without departing from the spirit or essential attributes thereof, and it is therefore desired that the various embodiments in the present disclosure be considered in all respects as illustrative and not restrictive. Thus, the breadth and scope of a preferred embodiment should not be limited by any of the above-described exemplary embodiments.

What is claimed is:

1. A vessel for training a helicopter pilot, comprising:
a hull that includes a structural framework that supports at least an aft deck and a superstructure, the superstructure being operatively positioned forward of the aft deck proximate a bow of the hull, the superstructure being disposed within a forward portion having a superstructure length that is within a range of approximately ten percent (10%) and approximately forty percent (40%) of a scantling length of the hull, wherein the aft deck includes a landing pad configured to withstand landing and takeoff forces during helicopter operations; and
a propulsion system at least partially disposed within the hull and configured to propel the vessel across a water surface.

2. The vessel of claim 1, wherein the aft deck is a single level deck that extends between approximately ninety percent (90%) and approximately sixty percent (60%) of the scantling length.

3. The vessel of claim 1, wherein the forward portion extends between approximately ten percent (10%) and approximately twenty percent (20%) of the scantling length from the bow.

4. The vessel of claim 3, wherein the aft deck is a single level deck that extends between approximately ninety percent (90%) and approximately eighty percent (80%) of the scantling length.

5. The vessel of claim 4, wherein the landing pad is disposed proximate to the forward portion and extends approximately fifty percent (50%) of the scantling length.

6. The vessel of claim 1, wherein the landing pad has a landing weight capacity of between approximately twenty thousand pounds and approximately ninety thousand pounds.

7. The vessel of claim 1, wherein the landing pad is coupled directly to the support framework of the hull and is configured to withstand landing impacts of approximately five gravities (5g's).

8. The vessel of claim 1, wherein the landing pad includes a haul-down system configured to apply a biasing force to a helicopter during a landing.

9. The vessel of claim 1, wherein the hull has a maximum hull width, and wherein the landing pad is a rectangular shape having a pad width that is between approximately seventy fifty percent (75%) and approximately one hundred twenty five percent (125%) of the maximum hull width.

10. The vessel of claim 1, wherein the aft deck has a deck midpoint, and wherein the landing pad has a pad midpoint that is disposed at or forward of the deck midpoint.

11. The vessel of claim 1, wherein the vessel comprises at least one of an Offshore Supply Vessel, an Offshore Support Vessel (OSV), a Platform Supply Vessel, or a Platform Support Vessel (PSV).

12. The vessel of claim 1, wherein the vessel is at least one of constructed or certificated under at least one of Title 46 of the United States of America Code of Federal Regulations Subchapters (I) or (L).

13. A vessel for training a helicopter pilot, comprising:
a hull that includes a structural framework that supports at least an aft deck and a superstructure, the superstructure being operatively positioned forward of the aft deck proximate a bow of the hull, the hull having a scantling length, the superstructure being disposed within a forward portion that extends from the bow, the forward portion being between approximately ten percent (10%) and approximately forty percent (40%) of the scantling length, the aft deck being positioned aft of the forward portion;
a propulsion system at least partially disposed within the hull and configured to propel the vessel across a water surface; and
wherein the aft deck includes a landing pad configured to withstand landing and takeoff forces during helicopter operations, wherein the aft deck has a deck midpoint, and wherein the landing pad has a pad midpoint that is disposed at or forward of the deck midpoint, the landing pad being coupled directly to the support framework of the hull and being configured to withstand landing impacts of approximately five gravities (5g's).

14. The vessel of claim 13, wherein the forward portion extends between approximately ten percent (10%) and approximately twenty percent (20%) of the scantling length from the bow, and wherein the aft deck is a single level deck that extends between approximately ninety percent (90%) and approximately eighty percent (80%) of the scantling length.

15. The vessel of claim 13, wherein the hull has a maximum hull width, and wherein the landing pad is a rectangular shape having a pad width that is between approximately seventy fifty percent (75%) and approximately one hundred twenty five percent (125%) of the maximum hull width.

16. A vessel for training a helicopter pilot, comprising:
a hull that includes a structural framework that supports an aft deck, the hull having a scantling length, wherein the aft deck includes a landing pad configured to withstand landing and takeoff forces during helicopter operations, wherein the landing pad is coupled directly to the support framework of the hull and has a landing pad midpoint that is disposed forward of or coincident with an aft deck midpoint of the aft deck;
a superstructure operatively coupled to the structural framework and disposed within a forward portion that is forward of the aft deck and proximate to a bow of the hull, the forward portion having a superstructure length that is between approximately ten percent (10%) and approximately forty percent (40%) of the scantling length; and
a propulsion system at least partially disposed within the hull and configured to propel the vessel across a water surface.
